(19) United States
(12) Patent Application Publication
(10) Pub. No.: US 2007/0282523 A1
(43) Pub. Date: Dec. 6, 2007

(54) METHOD AND DEVICE FOR DISPLAYING VEHICLE MOVEMENTS

(76) Inventors: Norbert Diekhans, Guetersloh (DE); Andreas Brunnert, Rietberg (DE); Lars Peter Meyer Zu Helligen, Spenge (DE); Gerhard Nienaber, Oelde (DE)

Correspondence Address: STRIKER, STRIKER & STENBY, 103 EAST NECK ROAD, HUNTINGTON, NY, 11743, US

(21) Appl. No.: 11/757,483

(22) Filed: Jun. 4, 2007

(30) Foreign Application Priority Data
Jun. 6, 2006 (DE) 10 2006 026 572.6

(51) Int. Cl. G06F 19/00

(52) U.S. Cl. 701/205; 701/201; 701/50

(57) ABSTRACT

In a method and a device for visualizing the movement of a vehicle, the vehicle includes at least one display unit coupled with a control and evaluation unit, and the control and evaluation unit is coupled with at least one track-following system for guiding the vehicle along driving routes, and the control and evaluation unit detects at least one characteristic orientation parameter that describes the orientation of the vehicle, and the control and evaluation unit—with consideration for the at least one characteristic orientation parameter of the vehicle—determines a virtual future driving track of the vehicle and this virtual future driving track is visualized in the display unit. In this manner, the operator of the vehicle obtains information about, at the least, which future driving track his vehicle will move on if the current vehicle orientation is maintained, and with consideration for characteristic parameters of the vehicle.

### CROSS-REFERENCE TO A RELATED APPLICATION

The invention described and claimed hereinbelow is also described in German Patent Application DE 10 2006 026 572.6 filed on Jun. 6, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a method and a device for visualizing the movement of a vehicle.

The related art makes known, among other things, route planning systems, which are used to record driving routes for a vehicle to be driven over a territory to be worked, and to enable the aforementioned vehicle to automatically implement previously programmed driving routes. For example, publication DE 43 42 171 describes the recording of routes that the soil-working machine has covered on a territory to be worked for a soil-working process which uses GPS-based position data. The driving route data on the agricultural working machine determined in this manner are then converted—depending on the design of the data processing device—in the particular agricultural working machine or in a central arithmetic unit into driving route data, which can then be displayed on-line or stored in a retrievable manner. Systems of this type have the disadvantage, in particular, that the vehicle must first work a certain driving route before that driving route is contained—in a retrievable manner—in the memory unit, and, optionally, before it is available—or capable of being visualized in any type of display units—as a basic data record used to generate driving routes to be worked in the future.

A route-planning method which is typically used today in combination with “automatic” track-following systems is disclosed, e.g., in U.S. Pat. No. 6,236,924. Since a territory to be worked is initially selected in a software-supported manner using distinct reference points and this selected territory is then divided into defined driving routes using various optimization criteria, a predefined route plan can be provided to the vehicle after the vehicle is automatically driven over the territory to be worked. Typically, the driving route that is being traveled at a particular point in time is recorded while the predefined driving routes are being worked. Systems of this type also have the disadvantage that the visualization of driving routes is limited to the route plan created in advance or to the driving route actually covered by the vehicle.

### SUMMARY OF THE INVENTION

The object of the present invention, therefore, is to avoid the disadvantages of the related art described above and, in particular, to provide a display system for visualizing movements of a vehicle that provides the operator of the vehicle with information that is above and beyond the known driving route information.

Accordingly, it is an object of the present invention to provide a method for visualizing a movement of a vehicle having at least one display unit which is coupled with a control and evaluation unit and at least one track-following system for guiding the vehicle along driving routes and coupled with the control and evaluation unit, the method comprising the steps of detecting by the control and evaluation unit at least one characteristic orientation parameter that describes an orientation of the vehicle; determining by the control and evaluation unit, with consideration for the at least one characteristic orientation parameter of the vehicle, a virtual future driving track of the vehicle; and visualizing the virtual future driving track in the at least one display unit.

It is another object of the present invention to provide a device for visualizing a movement of a vehicle, comprising a display unit; a control and evaluation unit coupled with said display unit; at least one track-following system for guiding the vehicle along driving routes and coupled with said control and evaluation unit; at least one track-following system for guiding the vehicle along driving routes and coupled with said control and evaluation units, said control and evaluation unit being configured so as to visualize in the display unit at least one element selected from the group consisting of a virtual future driving track of the vehicle, a target driving track of the vehicle, a curvature of a driving route, and a combination thereof, with consideration of at least one characteristic orientation parameter of the vehicle.

Given that the control and evaluation unit assigned to the vehicle determines a virtual future driving track for the vehicle with consideration for at least one characteristic orientation parameter of the vehicle, and this virtual future driving track is visualized in the display unit, the operator of the vehicle receives information about, at the least, which future driving track his vehicle will move on if the current vehicle orientation is maintained, and with consideration for characteristic parameters of the vehicle. This provides the operator of the vehicle with the option of intervening in the steering process at an early point in time in order to work a certain driving track, reliably avoid an obstacle, or to arrive at a subsequent driving track in a relatively precise manner and via a short route.

To ensure that the future driving track to be determined depicts, relatively well, the driving route that will actually be traveled by the vehicle, it is provided in an advantageous embodiment of the present invention that the characteristic orientation parameter(s) include the wheel base or the minimum turning circle of the vehicle, and the instantaneous steering angle. The future driving track that is determined and displayed represents the driving route that will actually be driven along by the vehicle that much more accurately when, in a further advantageous embodiment of the present invention, the characteristic orientation parameter(s) include the wheel base or the minimum turning circle of the vehicle, and a combination of the yaw rate and ground speed of the vehicle. The quality of the future driving track to be determined can be improved even further when the characteristic orientation parameters also include the orientation of the vehicle and the orientation of the driving route to be driven.

To ensure that the operator of the vehicle is continually informed about the moving behavior that he can expect of his vehicle—thereby enabling him to make corrections at an early stage or immediately—an advantageous embodiment of the present invention provides that the visualized virtual future driving track is determined and displayed continually.

A display of the future driving route that is easy for the operator to understand and that depicts the expected vehicle motions in a very real manner is attained when, in an advantageous embodiment of the present invention, the visualized virtual future driving track includes a radius of curvature, and the radius of curvature changes depending on the steering angle or the yaw rate.

In an advantageous refinement of the present invention, the virtual future driving track is displayed such that the current position of the vehicle is visualized in the display unit, and the virtual future driving track extends ahead of the visualized position of the vehicle in the direction of travel of the vehicle, as a guide line of the visualized position of the vehicle. In this manner, the operator of the vehicle is provided with a display system of the future movement of his vehicle that provides a good overview and is easy to understand.

A particularly effective navitation tool is made available to the operator of a vehicle when, in an advantageous embodiment of the present invention, one or more driving routes of the track-following system and the virtual future driving track are visualized in the same display. This has the particular advantage that the operator of the vehicle can use the display to select an optimal driving route and intentionally approach it, to reach the next driving track to be worked. The inventive display therefore also serves as a “merging tool” for the operator of the vehicle.

To provide a better overview via the display, it can be provided in an advantageous refinement of the present invention that the driving route to be traveled by the vehicle is subdivided into a large number of virtual support points, and the track curvature is determined for the contour section of the driving route located between adjacent support points and is visualized in a display unit. In this manner, the information that is relevant to the operator of the vehicle can be limited to the track radius that the vehicle must reach, thereby ensuring that the driving track predefined using the driving route is ultimately driven along.

In an advantageous embodiment of the present invention, the display unit can be designed such that the driving route and/or the track curvature of a contour section can be displayed. The operator of the vehicle is therefore provided with a navigation tool—which is adaptable to the needs of the operator in a flexible manner—that can be implemented in a highly flexible manner.

A particularly informative display that provides a good overview is attained when, in an advantageous refinement of the present invention, the track curvature of a contour section of the driving route visualized in a display unit corresponds to the instantaneous position of the vehicle on the driving route. The display is then limited to the instantaneous position of the vehicle on the driving route to be worked, i.e., the instantaneous position of the vehicle and the displayed driving route curvature are synchronized, thereby further increasing the information density of the display.

The overview provided by the display is improved even further when, in an advantageous embodiment of the present invention, the instantaneous position of the vehicle on the driving route in the display unit defines a foot at which the visualization of the curve of the track curvature of the particular contour section starts and extends in the direction of travel of the vehicle.

To ensure that the track curvature data on the driving routes determined once can be reused for subsequent driving routes having an identical structure, without having to always recalculate them, it is provided in an advantageous refinement of the present invention that the track curvatures determined are stored in an editable manner in the control and evaluation unit and can be called up repeatedly. In this context, it is advantageous for great flexibility of the display system when the radii of curvature of the stored track curvatures are modifiable, thereby making it possible to apply radii of curvature of the driving routes which have already been determined to future driving routes, and to ensure that they need be redetermined only in deviating areas.

Given that a target driving track of the vehicle is derived from the track curvature determined and from at least one characteristic orientation parameter of the vehicle, an extremely minimalistic display is attained that compresses a large amount of information such that, in the display, the operator is confronted only with a driving track to be worked. A simple technical implementation of this display structure is attained when the target driving track that is determined is visualizable in the display unit while the display of the particular driving route is simultaneously suppressed.

To ensure that the operator is informed about the target driving track that depends on the track curvature and at least one characteristic orientation parameter of the vehicle as well as information about the expected deviations in the movement of the vehicle from this target driving track, it is provided in an advantageous embodiment of the present invention that the target driving track determined and the virtual future driving track of the vehicle are visualized in the same display.

The information content of the display is more comprehensive yet clearly structured, thereby providing a good overview, when, in a further advantageous embodiment of the present invention, the instantaneous position of the vehicle, the target driving track that is determined, and the virtual future driving track of the vehicle are visualized together such that the target driving track and the virtual future driving track of the vehicle in the direction of travel of the vehicle are assigned, as curve sections, to the instantaneous position of the vehicle.

In an advantageous embodiment of the present invention, the length of the visualized curve sections of the target driving track, the virtual future driving track, and the track curvature are selectable. In this manner, the operator of the vehicle is provided with a highly flexible display that can be adapted specifically to the needs of the operator of the vehicle.

Given that the driving route capable of being traveled with the smallest possible turning circle is also visualized in the display unit, the operator is provided with additional navigation support that enables him to better predetermine the closest driving route or the shortest possible driving route.

The inventive method can be implemented in a manner having a simple design when the vehicle includes a display unit coupled with a control and evaluation unit, and the control and evaluation unit is coupled with at least one track-following system for guiding the vehicle along driving routes, and the control and evaluation unit visualizes, in a display unit, a virtual future driving track of the vehicle and/or a target driving track of the vehicle, and/or a curvature of the driving route, with consideration for the at least one characteristic orientation parameter of the vehicle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows the schematic view of a tractor with a track-following system in accordance with the present invention;

FIG. 2 shows the schematic view of the display unit of the tractor in FIG. 1 in accordance with the present invention;

FIG. 3 shows a detailed view of the structure of the display unit in FIG. 2 in accordance with the present invention;

FIG. 4 shows a further detailed view of the display unit in FIG. 2 in accordance with the present invention.

### DESCRIPTION OF THE PREFERRED EMBODIMENTS

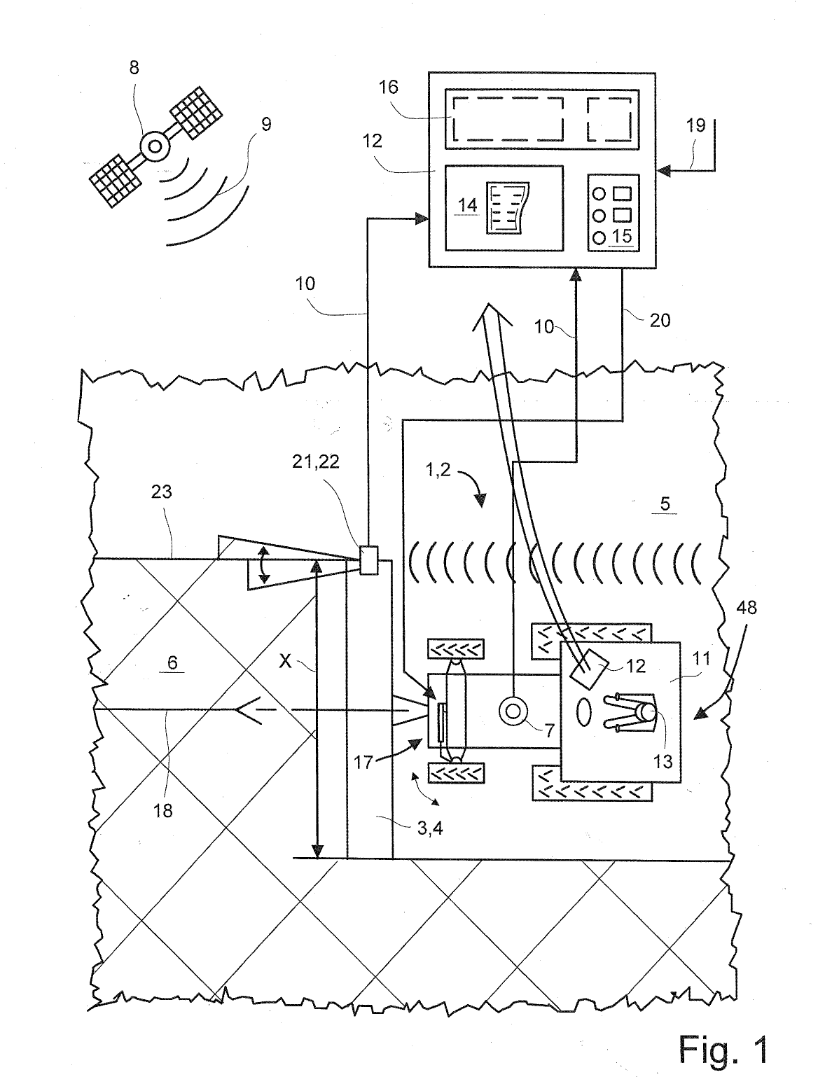

FIG. 1 shows a vehicle 1 designed as a tractor 2, to the front region of which a front attachment 4 designed as a cutting mechanism 3 is assigned, to harvest a crop 6 growing in a territory 5 to be worked. Tractor 2 includes a GPS locating device 7 known per se, which receives position signals 9 generated by GPS satellites 8 and, based on these, generates position signals 10 of tractor 2. In addition, at least one control and evaluation unit 12 is located within reach of operator 13 in driver's cab 11 of tractor 2, which includes at least one display unit 14, an input unit 15, and a programming module 16, as shown in its schematic enlargement in FIG. 1.

In addition, tractor 2 includes a steering system 17 which can be controlled automatically, so that tractor 2 can move automatically on predefined driving routes 18 in territory 5 to be worked. In the simplest case, this automated guidance of vehicle 1 can be carried out by storing driving routes 18 to be worked in control and evaluation unit 12, these driving routes 18 being generated externally or in control and evaluation unit 12 itself. If they are generated externally, external driving route signals 19 are then typically transmitted to evaluation and control unit 12 via remote data transfer. With consideration for position signals 10 of tractor 2 generated by GPS locating device 7, “steering signals” 20 are generated in control and evaluation unit 12 and are transmitted to steering system 17, so that vehicle 1 can be guided automatically on a defined driving route 18 in territory 5 to be worked. Systems of this type are referred to in general as track-following systems 48. It is within the scope of the present invention that position signals 10 of vehicle 1 can also be generated in territory 5 to be worked using optoelectrical locating devices 21, such as a laser scanner 22 which detects a crop edge 23. It is also within the framework of the present invention that vehicle 1 depicted as tractor 2 is any type of agricultural working machine, such as a combine harvester or any type of vehicle designed for non-agricultural applications, such as vehicles used in the construction industry.

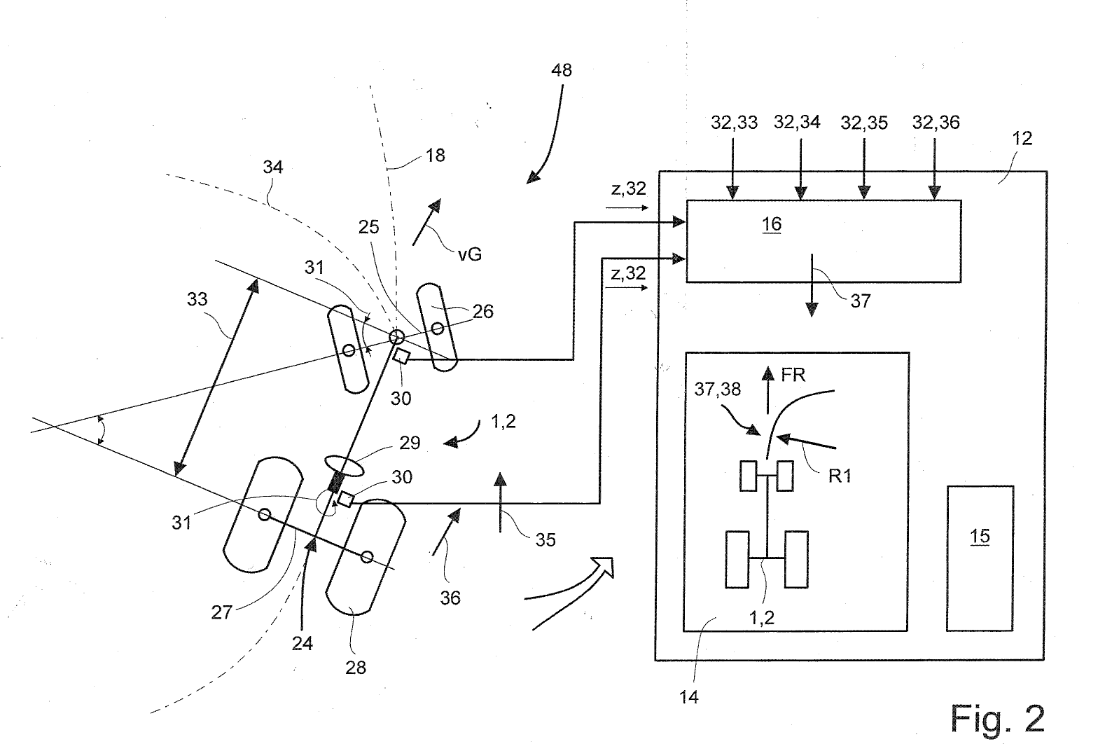

FIG. 2 shows a detailed view of vehicle 1 designed as a tractor 2, and an enlarged depiction of inventive display unit 14. Shown at the left in FIG. 2 is ground drive 24 of tractor 2 with front wheels 26 steerably located on front axle 25 and rear wheels 28 mounted rigidly on rear axle 27. A steering angle sensor 30 used to detect steering angle 31 is assigned to steering wheel 29 of tractor 2 and/or steered front wheels 26 in a manner that is known per se and will therefore not be described in greater detail. Detected steering angle signals Z are transmitted to programming module 16 of control and evaluation unit 12 and simultaneously represent one of the inventive characteristic orientation parameters 32 of vehicle 1.

In addition, the geometries of tractor 2, e.g., wheel base 33, the maximum permissible steering angle and the minimum turning circle 34 associated therewith, are known, and are also stored in programming module 16 of control and evaluation unit 12 as a component of inventive characteristic orientation parameters 32. If vehicle 1 does not include steering angle sensors 30, it is within the scope of the present invention that the orientation of vehicle 1 can also be determined by determining the yaw rate and the associated ground speed vG of vehicle 1. In a further embodiment of the present invention, it can also be provided that characteristic orientation parameters 32—which will be described in greater detail below—can include orientation 35 of vehicle 1 and orientation 36 of driving route 18 to be traveled, which are also transmitted to control and evaluation unit 12.

According to the present invention, a virtual future driving track 37 is determined in programming module 16 based on available characteristic orientation parameters 32 of vehicle 1. Mathematical relationships known per se can thereby take all previously described characteristic orientation parameters 32 into account, or only a selection thereof. A model having a simple mathematical structure would result, e.g., when this virtual future driving track 37 would be determined based solely on steering angle 31 that was determined, and on vehicle geometry 33. The shape of virtual future driving track 37 that is determined will reflect the actual conditions that much more precisely the greater the number of characteristic orientation parameters 32 is that are taken into account in its determination.

Given, e.g., that smallest possible turning circle 34 of vehicle 1 is also taken into account, it can be ensured that programming module 16 does not generate virtual future driving tracks 37 that vehicle 1 cannot work for technical, design-related reasons. In the exemplary embodiment shown in FIG. 2, virtual future driving track 37 of vehicle 1 that is determined is visualized in a manner such that vehicle 1 designed as tractor 2 is first depicted in display unit 14, and virtual future driving track 37 that was determined is assigned to the front thereof, as viewed in direction of travel FR, so that operator 13 of tractor 2 is shown clearly which driving track 37 tractor 1 would move along if the currently valid characteristic orientation parameters 32 were maintained.

Programming module 16 of control and evaluation unit 12 can also be designed such that it determines virtual future driving track 37 continually depending on characteristic orientation parameters 32, i.e., it updates and displays its shape continually. In the simplest case, virtual future driving track 37 is visualized such that it is depicted as a guide line 38 with a radius of curvature R1 determined based on characteristic orientation parameters 32; radius of curvature R1 is influenced decisively by steering angle 31 or the yaw rate. A visualization that operator 13 of vehicle 2 can comprehend quickly is attained when virtual future driving track 37 is always assigned, as guide line 38, to the front of vehicle 2 as viewed in direction of travel FR and, in the simplest case, to the center, so that guide line 38 always extends ahead of vehicle 1 shown.

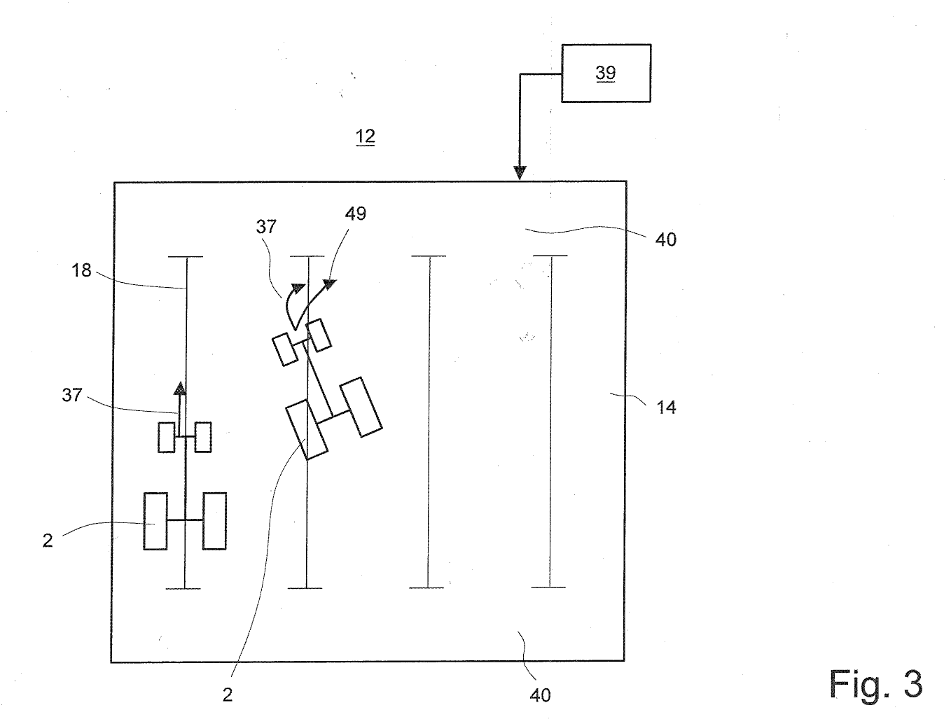

In FIG. 3, only display unit 14 of control and evaluation unit 12 is shown, for simplicity. A large number of driving routes 18 is first displayed in display unit 14, which were defined previously in a route planning system 39 that is integrated in control and evaluation unit 12 or is separate therefrom. Driving routes 18 can be designed straight, as shown, or they can be positioned in parallel with each other. It is also feasible, however, that driving routes 18 are designed curved in shape and are displaced relative to each other in a non-parallel manner. In addition, two different instantaneous positions of a tractor 2 are shown in display unit 14; inventive virtual future driving route 37 is assigned to the front of each of the symbolic depictions of the tractor. In the depiction shown at the left, virtual future driving route 37 extends nearly parallel with predefined driving route 18. In the other depiction, tractor 2 travels transversely to predefined driving routes 18; again, virtual future driving route 37 determined based on characteristic orientation parameters 32 is assigned to the front of the depiction of the tractor.

In a display structured in this manner, operator 13 can immediately see the deviation between predefined driving route 18 and virtual future driving route 37 that was determined, and he can carry out suitable steering measures to navigate vehicle 1 such that it reaches predefined driving route 18 once more, with a small amount of steering effort. In an agricultural application, a display principle of this type is of great help to operator 13 of an agricultural working machine in particular when vehicle 1 is located in header 40 and approaches the next predefined driving route 18 to be traveled. In this case, operator 13 can use the display directly as a navigation tool. A particularly effective navigation tool is provided when, in addition to virtual future driving route 37, driving route 49 for the smallest possible turning circle 34 is visualized in display unit 14.

Operator 13 of vehicle 1 can therefore make more efficient use of the manueverability of vehicle 1 as he navigates toward the next driving route 18. The display of driving route 49 that represents smallest possible turning circle 34 is significant in header 40 in particular, since operator 13 is provided with a means for estimating which of the closest driving routes 18 to be worked next can even be reached by vehicle 1 given its technical capabilities.

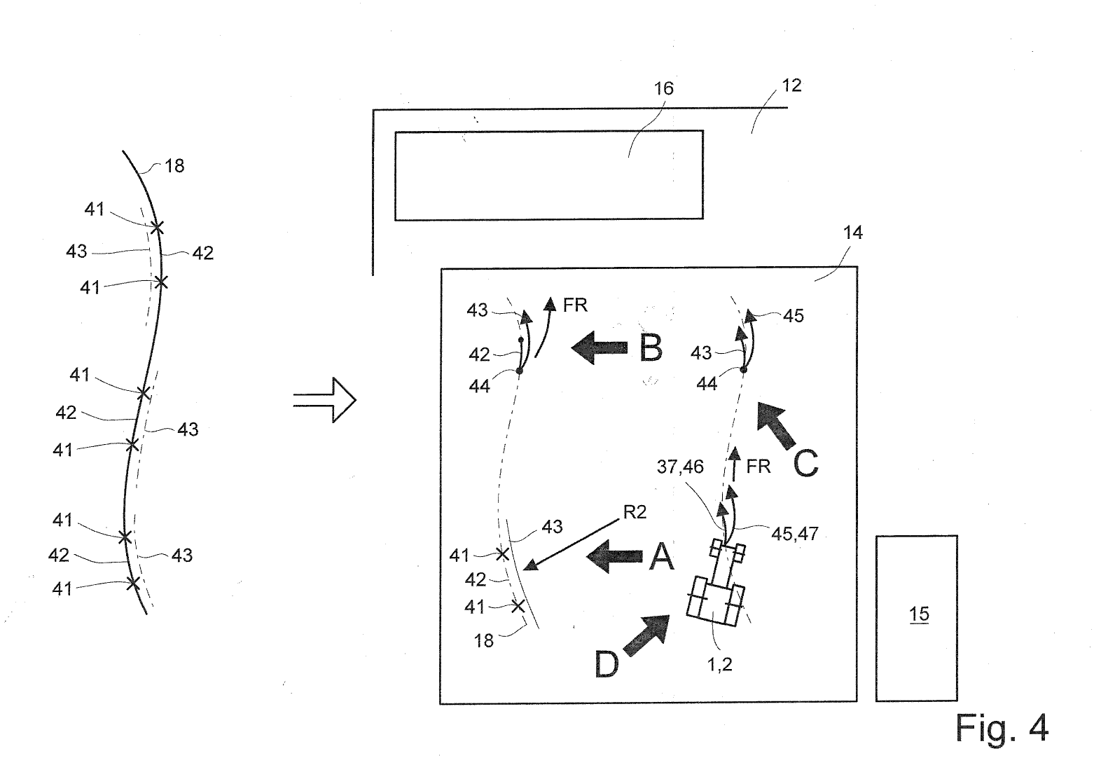

FIG. 4 shows a further embodiment of the structure of the display of inventive virtual future driving track 37, in a schematic depiction. A contoured driving route 18 composed of a curved line is shown. To describe driving route 18 mathematically, driving route 18 must first be subdivided into a large number of support points 41, then the instantaneous curvature 43 of driving route 18 is determined for contour section 42 located between adjacent support points 41. The definition of these curves 43 will describe the overall shape of driving route 18 that much better the more support points 41 there are and, therefore, the more contour sections 42 are formed on predefined driving route 17. In this manner, it is possible to also depict predefined driving route 18 such that curvature 43 of driving route 18 that occurs in a certain contour section 42 is displayable next to or on top of the actual contour of driving route 18 in display unit 14 of control and evaluation unit 12. A visualization structure that provides a particularly good overview results when track curvature 43 of a contour section 42 of driving route 18 visualized in display unit 14 corresponds to the instantaneous position of vehicle 1 on predefined driving route 18 (depiction A in FIG. 4).

The overview provided by the display can be improved even further by designing it such that the instantaneous position of vehicle 1 on driving route 18 in display unit 14 defines a foot 44 at which the visualization of track curvature 43 of particular contour section 42 starts and extends in direction of travel FR of vehicle 1 (depiction B in FIG. 4). A highly flexible use of inventive control and evaluation unit 12 results when determined curvatures 43 of driving routes 18 are stored in control and evaluation unit 12, e.g., in programming module 16, such that they can be edited and called up repeatedly. In this manner, track curvatures 43 that have already been determined can be used once more to depict parallel and identically contoured driving routes 18 or sections thereof, without the need to subdivide them once more into contour sections 42 and to calculate particular curvature 43. The flexibility of the system is increased further, e.g., by the fact that radii of curvature R2 of driving routes 18 that have been determined and stored can be edited using input unit 15, thereby giving operator 13 of vehicle 1 the option to change the shape of a driving route 18 immediately by entering radii of curvature R2.

Given that curvature 43 of a contour section 42 of predefined driving route 18 determined in this manner is calculated using a selection of or all of the characteristic orientation parameters 32 described above in the manner described for determining virtual future driving track 37, the result that is obtained is a target driving track 45 (depiction C in FIG. 4), which now takes the driving route-specific data and vehicle-specific data into account, thereby making it possible for particular vehicle 1 to work target driving track 45 determined in this manner more precisely, since it is better aligned with its technical capabilities. An improved overview is attained in this context when the display of predefined driving route 18 is suppressed when newly determined target driving track 45 is displayed.

According to the depiction D in FIG. 4, in a further advantageous embodiment, the visualization by display unit 14 can be designed such that target driving track 45 determined depending on characteristic orientation parameters 32 and virtual future driving track 37 determined with consideration for characteristic orientation parameters 32 are displayed together. A particularly advantageous embodiment also results in this case when the instantaneous position of vehicle 1, target driving track 45 that is determined, and virtual future driving track 37 of vehicle 1 are visualized together such that target driving track 45 and virtual future driving track 37 of vehicle 1 in direction of travel FR of vehicle 1 are assigned as curve sections 46, 47 to the instantaneous position of vehicle 1. In addition, the length with which curve sections 46, 47 and displayable track curvature 43 are shown in display unit 14 can be varied, e.g., by entering a length via input unit 15. It would also be feasible for the length that is displayed to be defined depending on ground speed. In this case, the length could represent, e.g., the length of a route that vehicle 1 will cover in a defined window of time, e.g., in the next 10 seconds.

It lies within the abilities of one skilled in the art to modify the method described and the associated device in a manner not shown or to use it in applications other than those described, in order to obtain the effects described, without leaving the scope of the present invention.

It will be understood that each of the elements described above, or two or more together, may also find a useful application in other types of constructions differing from the type described above.

While the invention has been illustrated and described as embodied in a method and device for displaying vehicle movements, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method for visualizing a movement of a vehicle having at least one display unit which is coupled with a control and evaluation unit and at least one track-following system for guiding the vehicle along driving routes and coupled with the control and evaluation unit, the method comprising the steps of detecting by the control and evaluation unit at least one characteristic orientation parameter that describes an orientation of the vehicle; determining by the control and evaluation unit, with consideration for the at least one characteristic orientation parameter of the vehicle, a virtual future driving track of the vehicle; and visualizing the virtual future driving track in the at least one display unit.

2. A method as defined in claim 1; and further comprising including in the characteristic orientation parameter a parameter selected from the group consisting of a wheel base of the vehicle and a minimum turning circle of the vehicle, and an instantaneous steering angle.

3. A method as defined in claim 1; and further comprising including in the characteristic orientation parameter a parameter selected from the group consisting of a wheel base of the vehicle and a minimum turning circle of the vehicle, and a combination of a yaw rate and a ground speed of the vehicle.

4. A method as defined in claim 1; and further comprising including in the characteristic orientation parameter an orientation of the vehicle and an orientation of a driving route to be driven.

5. A method as defined in claim 1, wherein said determining and displaying includes determining the virtual future driving track and displaying the determined virtual future driving track continually.

6. A method as defined in claim 1; and further comprising changing a radius of curvature of the visualized virtual future driving track depending on a parameter selected from the group consisting of a steering angle and a yaw rate.

7. A method as defined in claim 1, wherein said displaying includes displaying the virtual future driving track such that a current position of the vehicle is visualized in the display unit, and the virtual future driving track extends ahead of the visualized current position of the vehicle in a direction of travel of the vehicle as a guide line of the visualized current position of the vehicle.

8. A method as defined in claim 1; and further comprising visualizing one or more driving routes of the track-following system and the virtual future driving track in the display which is a same display.

9. A method as defined in claim 1; and further comprising subdividing a driving route to be driven along the vehicle into a large number of virtual support points; determining a track curvature for a contour section of the driving route located between adjacent ones of the support ports; and visualizing it in the display unit.

10. A method as defined in claim 9; and further comprising displaying in the display unit an element selected from the group consisting of the driving route, the track curvature of the contour section, and both.

11. A method as defined in claim 10; and further comprising providing the track curvature of the contour section of the driving route visualized in the display unit so that it corresponds to an instantaneous position of the vehicle on the driving route.

12. A method as defined in claim 11; and further comprising defining by the instantaneous position of the vehicle on the driving route in the display unit a foot in which a visualization of the curvature of a particular contour section starts and extends in a direction of travel of the vehicle.

13. A method as defined in claim 9; and further comprising storing the determined curvature of the contour sections of the driving routes in an editable manner in the control and evaluation unit; and calling the stored determined curvatures up repeatedly.

14. A method as defined in claim 13; and further comprising modifying radii of curvature of the stored curvatures.

15. A method as defined in claim 7; and further comprising deriving a target driving track of the vehicle from the curvature that was determined and at least one characteristic orientation parameter of the vehicle.

16. A method as defined in claim 15; and further comprising visualizing the determined target driving track in the display unit, while simultaneously suppressing a display of a particular driving route.

17. A method as defined in claim 1; and further comprising visualizing a target driving track and the virtual future driving track of the vehicle on the display which is the same display.

18. A method as defined in claim 17; and further comprising visualizing together an instantaneous position of the vehicle, the target driving track that is determined and the virtual future driving track of the vehicle, such that the target driving track and the virtual future driving track of the vehicle in a direction of travel of the vehicle are assigned as curved sections to an instantaneous position of the vehicle.

19. A method as defined in claim 18; and further comprising providing a length of the visualized curve sections of the target driving track, the virtual future driving track, and a curvature of contour sections of driving routes so that they are selectable.

20. A method as defined in claim 1; and further comprising visualizing in the display unit a driving route capable of being traveled with a smallest possible turning circle.

21. A device for visualizing a movement of a vehicle, comprising a display unit; a control and evaluation unit coupled with said display unit; at least one track-following system for guiding the vehicle along driving routes and coupled with said control and evaluation unit, said control and evaluation unit being configured so as to visualize in the display unit at least one element selected from the group consisting of a virtual future driving track of the vehicle, a target driving track of the vehicle, a curvature of a driving route, and a combination thereof, with consideration of at least one characteristic orientation parameter of the vehicle.
